(19) United States
(12) Patent Application Publication
(10) Pub. No.: US 2015/0249258 A1
(43) Pub. Date: Sep. 3, 2015

(54) APPARATUS AND METHOD FOR PRODUCING ELECTROCHEMICAL CELLS

(71) Applicant: BASF SE, Ludwigshafen (DE)

(72) Inventors: Hannes Wolf, Ludwigshafen (DE); Klaus Leitner, Ludwigshafen (DE); Andreas Mueller, Floersheim-Dalsheim (DE); Armin Brenner, Eppelheim (DE)

(73) Assignee: BASF SE, Ludwigshafen (DE)

(21) Appl. No.: 14/430,372

(22) PCT Filed: Nov. 12, 2013
(86) PCT No.: PCT/EP2013/073540

§ 371 Date: Mar. 23, 2015

Related U.S. Application Data
(60) Provisional application No. 61/729,360, filed on Nov. 22, 2012.

(30) Foreign Application Priority Data
Nov. 22, 2012 (EP) 12193837.7

(51) Int. Cl. H01M 10/04

(52) U.S. Cl. CPC H01M 10/0404; H01M 10/049

(57) ABSTRACT

The invention relates to an apparatus and a method for producing electrochemical cells, preferably Li-ion cells. The apparatus comprises at least one placing location (13, 15, 17, 19), at least one assembly location (2, 4), a robot system (3) with gripper (150), an automated pipetting machine (5) with cleaning station, a tool for sealing cell stacks and at least one tray with depressions for accommodating components, the number of depressions being in total greater than or equal to two, preferably greater than or equal to four and particularly preferably greater than or equal to six. For assembling the cells, the individual components E1 to E5 are placed in trays on the placing locations and are automatically moved from there by a gripper to the assembly zone and positioned. The zones between the components E2 and E3 and between E3 and E4 are filled with electrolyte. Characteristic features of the apparatus include extremely flexible use with regard to varying different process parameters, elevated throughput and a low reject rate for the produced Li-ion cells.

Electrochemical cells are of great industrial significance as energy storage means. The present invention relates to an apparatus and a method for producing electrochemical cells, preferably lithium-ion cells. The apparatus comprises at least one placing location (13, 15, 17, 19), an assembly location (2, 4), a positioning system (3) with gripper (150), an automated pipetting machine (5) with cleaning station, a tool for sealing cells assembled by stacking and at least one tray with depressions for accommodating components, the number of depressions being in total ≧two, preferably ≧four, particularly preferably ≧six. The apparatus may furthermore also be equipped with a balance (1) and/or camera (25). The modules of the apparatus are preferably enclosed by a housing (8), preferably a glovebox. The housing is in operative connection with at least one airlock (23).

Automated production machines for the mass production of electrochemical cells are known from the prior art. However, automated production machines for mass production do not permit variation in the production parameters during manufacture of the electrochemical cells. The development of new and improved electrochemical cells is not possible with this kind of automated machine.

For example, the prior art, specifically CN 102290602, CN 201540925 and CN 201829565, discloses a type of apparatus which is based on the use of a rotary table or a conveying table. The various manufacturing stations for producing the cells are arranged around the rotary table. The components are placed in a circle around the center point on the surface of the rotary table and moved by the rotary motion to the individual points of the manufacturing station.

CN 102013496 moreover discloses an apparatus for assembling foil casings. The casings are here conveyed on a conveyor belt along the longitudinal axis of the apparatus, the same process steps being repeatedly carried out at various positions.

The prior art contains no details regarding the housing which encloses the respective manufacturing apparatuses. It should, however, be assumed that the manufacturing apparatuses must be located in protection zones as it is stated that the manufacturing apparatuses are used for producing Li cells. Because Li cells are being manufactured, it should be ensured that the cells are manufactured with exclusion of at least oxygen and atmospheric humidity.

Apart from the above, the prior art also discloses individual tools which may be used as modules in the manufacture of battery cells. These are grippers which may be used for handling cell components.

CN 201540925 discloses means for handling foils.

CN 102044663 discloses a method and an apparatus for laminating foil electrodes.

Automated battery production processes are also described in the literature (see for example Li, Sha; Wang, Hui; Hu, S. Jack; Lin, Yhu-Tin; Abell, Jeffrey A., J. of Manufacturing Systems 30 (2011), p. 188-195). Automated battery production processes generally relate to the manufacture of batteries from a plurality of identical cells, it in particular being the electrodes and electrolyte which are identical. The plurality of cells are here formed from stacks of individual pouch cells which are sensitive and therefore entail stringent handling requirements.

One objective in developing electrochemical cells is to obtain electrochemical cells which have a long service life and from which the stored energy can be retrieved within a very short time. Hitherto produced Li-ion cells have energy storage densities with values which may for instance be in the range from 70 up to 150 Wh/kg. The theoretical limit for the energy density of Li cells is, however, still higher. It is therefore to be assumed that energy density may be raised still further. Further objectives for optimization, in addition to energy density, are cycling capability and load rating. In contrast, lead-sulfuric acid storage batteries only have an energy density with a value in the range from 30 to 40 Wh/kg. Due to the large difference between the energy density which has previously been achieved in practice and the energy density which could theoretically be achieved, there is still great potential for research and development departments to identify novel electrochemical cells which exhibit better performance characteristics.

One of the objects of the invention is to provide an apparatus and a method by means of which the production of electrochemical cells may be made extremely flexible.

The above-stated object and further objects are achieved in that an apparatus for producing electrochemical cells is provided which comprises at least one placing location (13, 15, 17, 19), an assembly location (2), a positioning system (3) with gripper (150), an automated pipetting machine (5) with cleaning station, a tool for sealing cells assembled by stacking and at least one tray with depressions for accommodating components, the number of depressions being in total ≧two, preferably ≧four, particularly preferably ≧six.

### Apparatus for Producing Electrochemical Cells

In a preferred embodiment, the apparatus comprises a balance (1) and/or at least one camera (25), the camera (25) being arranged in the region of the base plate of the apparatus. The lens of the first camera is directed vertically upward.

The lateral position of the component gripped by the gripper is determined by means of the camera. This determination of position makes it possible to carry out location correction when positioning the component. Component placing accuracy is increased. At the same time, in a preferred embodiment it is possible to carry out a surface analysis of the bottom of the respective component, in particular of the electrodes and/or separators, by means of the camera. The surface analysis characterization data (preferably of the electrodes or separators) are acquired by the sequence control system and stored in the database. In a preferred embodiment, the image data from the camera are compared with reference data and used as the decision-making basis for sorting the currently gripped part. This process is implemented in the sequence control system or in the program software.

In another embodiment, the apparatus is equipped with a second camera (25′), which is arranged in the upper part of the housing and the lens of which is directly vertically towards the base plate. The camera is preferably arranged in the region above the balance (1). The top of the respective component, preferably of the electrodes and/or separators, is analyzed by means of the second camera. The surface analysis data are acquired by the sequence control system and stored in the database. In a further preferred embodiment, these image data are compared with reference data and used as the decision-making basis for sorting the component currently under evaluation. The process proceeds by means of a sequence control system or software.

It is furthermore preferred for the apparatus to comprise means for moving the tray to the at least one placing location (13, 15, 17, 19) or the trays to the placing locations.

In a preferred embodiment, the apparatus according to the invention is an apparatus for producing Li-ion cells and the individual modules of the apparatus are enclosed by a housing (8), preferably a glovebox, and the housing is in operative connection with at least one airlock (23), preferably two airlocks (23, 10). The glovebox (8) contains means for controlling and monitoring the atmosphere in the interior thereof.

In a preferred embodiment, the apparatus according to the invention comprises a base plate;

the base plate is, for example, of a size of 100 cm×200 cm. The base plate and the components described below are enclosed by a glovebox. The primary function of the glovebox is to keep air and atmospheric humidity away from the assembly zone. The glovebox preferably comprises means for monitoring and controlling the gas atmosphere, whereby the gas atmosphere may be purposefully predetermined. The gas feed line may furthermore also be provided with gas purification means.

The placing location preferably has means for recognizing the position of the trays.

In a further preferred embodiment, the apparatus comprises a guide which is located in the placing zone, the assembly zone and/or the airlock zone. The trays may, for example, be moved in the placing zone along the guide and fixed at selected locations with elevated positioning accuracy. Thus, in addition to the location recognition means during positioning, appropriate fastening means are furthermore preferably also present. Accurate spatial positioning and fixing are particularly advantageous as this means that grippers are capable of picking components with elevated positioning accuracy.

In the airlock zone, the guide may also act as a mount for accommodating the trays. The trays are preferably stackable and a plurality of trays may be stacked on one another within the airlock. When transferring the trays from the airlock into the glovebox, it is possible for first of all a whole stack of a plurality of trays to be moved along a guide in the airlock towards of the interior of the glovebox. More space is available in the interior of the glovebox, for moving the stacked trays from the stack to the respective placing positions if a plurality of loaded trays is simultaneously transferred inward.

The elevated positioning accuracy when fixing the trays at specific placing positions in the placing zone is of significance as this assists the gripper in heading for the depressions and picking the components located therein. The components used for producing the electrochemical cells may in part be of very small dimensions and also of very low masses. The apparatus according to the invention makes it possible for the gripper to pick and handle the individual components in a virtually trouble-free manner.

The trays provided with depressions are an essential feature of the invention, as they are interchangeable and enable extremely flexible use in the apparatus according to the invention. It is also of significance for the information associated with the respective tray to be stored in the sequence control system. The information comprises, for example, the number of depressions m_{y}, the size of the depressions and the shape and location coordinates thereof. The number of depressions is determined by the size of the cells to be produced. For example, the number of depressions is greater for producing coin cells than the number of depressions for producing pouch cells. Furthermore, information regarding how the individual depressions are populated with components is saved in the sequence control system.

At least one position for accommodating a tray must always be available in the region of the placing location (13, 15, 17, 19). Preferably, however, the placing location has two or more positions for accommodating trays. Trays having the same dimensions are preferably always assigned to the respective positions, since they may then readily be transferred inward, positioned and fixed by means of the feed rail.

In a preferred embodiment, all trays are of identical dimensions and may be fastened at all positions of the placing location or placing locations (13, 15, 17, 19). Interchangeability of trays is of significance to the highly flexible use of the apparatus. For example, the apparatus may very straightforwardly be changed over from use for producing coin cells to use for producing pouch cells, and vice versa. If the apparatus has means both for sealing coin cells and for sealing pouch cells, both types of cells may be produced in alternating succession. The means for sealing the cells may preferably take the form of individual processing stations.

A placing zone is, for example, arranged on the base plate along one lengthwise edge. Along the opposing lengthwise edge are located a plurality of measuring and processing stations for carrying out the individual method steps for producing the cells. In a preferred embodiment, the processing stations comprise a balance (1), an electronic camera (25) with image recognition software, a tool for sealing the electrochemical cells, for example a press for manufacturing coin cells, an automated pipetting machine (5) for dispensing liquid electrolyte and a station for cleaning the tips of the automated pipetting machine. In an alternative embodiment, a more complex station for manufacturing pouch cells is provided instead of the press. It is also possible to provide both means for sealing coin cells and a module for sealing pouch cells.

In the glovebox (8) is located a positioning system (3) which can reach any point above the plate by means of a gripper (150). The achieved positioning accuracy preferably amounts to 0.4 mm, more preferably to 0.2 mm and particularly preferably to 0.1 mm. All the stated components are in electronic communication with a control computer which coordinates the processing stations and the conveying steps. FIG. 1 shows a schematic plan view. The positioning system may for example take the form of a gantry system (3) or a buckling arm robot (3′). Any other kind of positioning may likewise be used.

It may be stated with regard to the gripper arm and the gripper (150) of the gantry system that the size of the gripper is adapted to the objects to be placed; it is preferably a suction gripper since it is preferably planar components which are positioned. The suction gripper requires one or more planar working surfaces. This is of significance in particular when gripping rotationally symmetrical components. When handling non-rotationally symmetrical components, if for example triangular or quadrangular components are being placed, the suction gripper is coupled with the gantry system via a rotary system, such that the components picked up by the gripper (150) may be rotated in the plane of the base plate both clockwise and anticlockwise in each case by at least 10°, preferably by 22.5°, more preferably by 45°, the resolution during rotation being >0.4°, preferably >0.2°, more preferably >0.1°.

In a preferred embodiment, the placing zone comprises as guide a linear guide system which serves to accommodate trays for the constituents of the cells. Means are provided along the guide thanks to which the individual trays assume fixed and precisely predefined positions. Positioning of the trays proceeds highly reproducibly. Positioning of the trays also includes detachable fixing thereof.

In a preferred embodiment, the housing, preferably glovebox (8), is in operative connection with at least one airlock (23). The trays are transferred inward through the airlock (23) into the placing zone of the housing and fixed in defined placing positions in the placing zone. An arrangement in which an airlock (23, 10) is located at both ends of the guide is moreover further preferred.

The airlocks have a means for gas exchange and at least one airlock (23) has a means for heating. In the airlocks, the components are pretreated before being introduced into the housing in order as far as possible to remove the constituents of air, and in particular also moisture. These means in particular comprise a device for applying a vacuum and flooding with inert gas.

The reduced pressure achievable in the airlock(s) is preferably >5 mbara, more preferably >1 mbara and particularly preferably 0.1 mbara and the temperature during heating is in the range from 20 to 200° C., preferably 50 to 180° C., particularly preferably 80° C. to 160° C. The pressures are stated in bar absolute (bara).

### Guidance and Coupling of Trays

It is furthermore preferred for the apparatus to comprise a device for guiding the trays, which device for example comprises one or more guide rails and guide elements. The guide elements are mounted on the trays. Guide elements which may be used are inter alia sliding guide elements, rollers, ball bearings. The guide preferably comprises a linear guide. The trays provided with the guide elements are placed on the guide and may be moved along the guide to precisely predetermined positions within the apparatus. The predetermined positions are the placing locations (13, 15, 17, 19).

In a preferred embodiment, the trays may be provided with an electric drive by which they are then moved to the positions of the placing locations (13, 15, 17, 19).

In another preferred embodiment, and in the event that the apparatus is installed in a glovebox, the trays are moved by manual intervention along the guide rails from the interior of the airlock to the individual placing locations (13, 15, 17, 19), from one of the placing locations to the next placing location or from the placing locations into the airlock. The term “placing location” may refer to specific placing locations (13, 15, 17, 19) or also to an entirety of placing locations. The use of reference signs is not intended to restrict the term. The trays may also be present on the placing locations in stacked form, which is in particular preferred in connection with the use of the placing locations in the airlock.

It is moreover further preferred for the ends of the individual trays to comprise couplings. Using the couplings, a plurality of trays may be linked together and then form a serial arrangement of trays. The serial arrangement of the trays coupled together may be both pushed and pulled along the guide. This substantially improves handling of the trays within the apparatus, since a whole group of trays is simultaneously conveyed with a single drive or a single intervention in the interior of the glovebox.

The coupling elements are preferably located laterally on the trays, as shown in FIGS. 5.a-5.c. The coupling elements allow pushing or pulling of the trays along the guide. The couplings are constructed such that a preferred spacing remains between the trays which makes it possible to grasp the trays manually.

The spacing between the individual trays connected with couplings is preferably in the range from 1 to 4 cm, the spacing preferably amounting to less than 3 cm. In a further embodiment, which is likewise preferred, the couplings are hook shaped as shown in FIG. 5.a, the hooks being of complementary construction, such that, in the case of adjacent trays as shown in FIG. 5.b, they can engage with one another.

The hooks are preferably constructed with an oversize, so giving rise to a clearance in the pulling or pushing direction, preferably of <5 mm, more preferably of <4 mm and particularly preferably of <3 mm. The presence of clearance makes it possible to position and fix the trays along the guide rails. The positioning and fixing process is also known as indexing. Indexing is effected, for example, via pneumatically actuated metal pins which, for example, latch in bores in the trays. Indexing is advantageous for economic operation of the apparatus.

Because the location of these bores is very precisely defined, the trays are oriented relative to the positioning system.

In a further preferred embodiment, the coupling elements comprise permanent magnets (see FIG. 5.c). The trays provided with permanent magnets are linked to one another in such a manner that, when two trays are adjacent, in each case one coupling element with a magnetic north pole and one coupling element with a magnetic south pole meet up with one another.

The magnets are held in position by means of a holding rod which is mobile relative to the coupling. A resilient element, for example a spiral spring, is furthermore located on the holding rod, which resilient element makes it possible to position the trays in the pulling/pushing direction with a tolerance of 5 mm, preferably of 4 mm, more preferably with 2 mm of clearance, such that indexing is possible here too. FIG. 6.a is a schematic depiction of a magnetic coupling element in the preferred embodiment. The clearance ensures indexability, i.e. repositionability in a spatially defined position and, consequently, fastening.

The components of the cells, i.e. the casing parts (E1, E5), electrodes (E2, E4) and separators (E3) are introduced into the depressions of the trays in the placing zone. The trays preferably comprise rectangular plates with a planar face, wherein the length times width is in the range between 10×10 cm and 50×50 cm and the height or thickness of the trays preferably amounts to <5 cm, more preferably to <2 cm and particularly preferably to <1 cm. The depressions are wells with the contour of the respective components which are stored in a depression. The depressions are preferably in a matrix arrangement. FIG. 3 shows one arrangement by way of example. The trays comprise channels or milled portions which permit gas exchange between the interior of the depressions and the outside of the trays when the components are heated in the vacuum airlock. It is also of significance for it also to be possible for gas exchange between the interior of each individual depression and the outside of trays to take place when the trays are stacked on one another.

Due to their small size and slight layer thickness, some components of the cells are of a foil-like nature. This gives rise to the problem that the components remain stuck to one another and purposeful removal of individual parts is disrupted. In an advantageous embodiment, separator elements (103), which prevent the components (102) from sticking together, are in each case inserted between the individual components, as shown in FIG. 2.b.

These separator elements may for example consist of plastics, conductive plastics, conductively coated plastics or of thin metal sheets. The separator elements are preferably equipped in an embossing method with guide lugs (100) and centering points, such that, when two separator elements are laid on one another, a two-dimensional interspace for accommodating the foil-like constituents (102) is obtained therebetween. The embossed contours of the separator elements (103) furthermore have the task of positioning the foil-like electrodes and separators with a tolerance of 5 mm, preferably of 2 mm, preferably of 1 mm in the plane of the table. The separator elements may also be provided with flexible tongues which act as hold-down members to prevent foils coated on one side from curling.

In a preferred embodiment, the trays provided with components are firstly stacked in the airlock (23) and subjected to a conditioning program. After conditioning, the trays are introduced into the placing zone, where they are positioned and fixed. Means are present for populating the placing locations (13, 15, 17, 19) with the trays. This step may, however, for example also be performed manually, if handling holes with gloves (14, 16, 18, 20), which enable the operator to intervene in the housing, are mounted in the housing, preferably glovebox (8).

In a preferred embodiment, an automated pipetting machine (5), with which liquid components may be applied onto the electrode of the cells or onto the separator, is located above the base plate. The automated pipetting machine draws up the electrolyte L₁ which is to be dispensed from a storage zone and dispenses it in predetermined quantities into the cell to be assembled. Dispensing accuracy here amounts to +/−0.1 μL at a dispensed quantity of 10 μL per dispensing point. The dispensing device here either has its own means for positioning or is for example coupled to the gantry system and is positioned by the latter at least in one axis.

In a further preferred embodiment, the apparatus is characterized in that it comprises a plurality of vessels with electrolytes L₁ to L_{N}, wherein N is >2. The number of electrolyte vessels N is preferably >10 (L₁-L₁₀) and more preferably the number of electrolyte vessels N is >20. A number of electrolyte vessels N of >100 is also conceivable and possible.

The storage zone for the electrolyte comprises vessels with a pierceable membrane closure through which needle of the automated pipetting machine can penetrate. The size of the vessels which may be used is variable and is determined on the basis of the particular working program. If the influence of the composition of the electrolytes on the performance characteristics of the electrochemical cells is to be investigated, it is convenient to use a relatively large number of electrolyte vessels with a small storage capacity, for example in the form of a matrix arrangement with 10×10 vessels, each of which has a storage capacity of 2-5 ml of electrolyte solution. If, on the other hand, the influence of the electrodes on the performance characteristics of the electrochemical cells is to be investigated, it is convenient to use only a few or even just one single electrolyte. In this case, electrolyte vessels are then used which have a larger storage capacity. An arrangement of 3×3 vessels, each with a storage capacity of 20-50 ml, is for example suitable.

The apparatus according to the invention is characterized in that it is put to extremely flexible use in the laboratory for research purposes. With regard to sizing and capacity, the apparatus according to the invention is therefore subject to certain limits regarding throughput and design. The elevated flexibility is also a result of the modular construction of the apparatus. The apparatus may also be used for long-term operation, by which means the efficiency of use of the apparatus may be increased.

### Long-Term Operation of the Apparatus

It is a further object to provide an apparatus and method for producing electrochemical cells which is operated over a long period with low expenditure.

One essential aspect of the apparatus according to the invention is that a specific quantity of cells is manufactured and, at the same time, the parameters of the individual cells is varied in defined manner. Due to the use of the trays, manufacturing does not relate to a continuous production process of a large number identical cells, but instead to the manufacture of a plurality of different cells. Production is subject to limitations with regard to the upper limit in terms of number of units.

A preferred embodiment makes use of an automated pipetting machine which uses one liquid for avoiding its becoming contaminated and for operation. This liquid is hereafter designated “system liquid”. The system liquid preferably consists of one of the components of the electrolyte, furthermore preferably of the component which is liquid and completely volatile under standard temperature and pressure. The system liquid is required in an at least ten-fold excess ratio relative to the dispensed amount, it being necessary to dispose of the liquid from the glovebox once it has been used. Typical quantities of system liquid are of the order of magnitude of 1-5 liters per day. The apparatus according to the invention accordingly comprises at least one container for system liquids and at least one container for liquid waste. The capacity of the liquid container for system liquid preferably amounts to 2 to 20 liters, more preferably to 5 to 15 liters. The capacity of the container for liquid waste is greater than the capacity of the container for system liquids by at least 1 liter, preferably by at least 2 liters. The containers are preferably designed such that they may also be flooded with inert gas in order to safeguard against contamination of the atmosphere in the interior of the housing, preferably the glovebox.

In a preferred embodiment, the apparatus according to the invention comprises at least one container for a system liquid for operation of the automated pipetting machine and at least one container for liquid waste. The capacity of the liquid container for cleaning liquid preferably amounts to 2 to 20 liters, more preferably to 5 to 15 liters. The capacity of the container for liquid waste is greater than the capacity of the container for cleaning liquids by at least 1 liter, preferably by at least 2 liters.

The containers are preferably designed such that they may also be flooded with inert gas in order to safeguard against contamination of the atmosphere in the interior of the housing, preferably the glovebox.

The manner in which the apparatus according to the invention is equipped with the containers for system liquid and liquid waste is selected such that the apparatus may be operated with little maintenance effort and without extended interruptions in operation. The interruptions occur when, for example, the storage containers for the electrolyte fluids are replaced. Operation of the apparatus is also sometimes interrupted during inward or outward transfer of the trays.

The electrolyte is dispensed by means of a handling system for liquids, preferably by means of an automated pipetting machine. The automated pipetting machine requires a system liquid for cleaning and for operation. The major proportion of the system liquid advantageously consists of the major component of the electrolyte liquid. For the purpose of cleaning, the system liquid is passed through the lines of the automated pipetting machine so that any possible additives which might have been deposited in the lines of the automated pipetting machine are dissolved and rinsed away.

It should also be borne in mind that an overpressure of inert gas prevails in the interior of the housing of the apparatus or within the glovebox, whereby the interior is very effectively protected against penetration of air, which of course contains oxygen, nitrogen and moisture, from outside the apparatus.

The apparatus, which is equipped with the containers for system liquid and liquid waste, preferably also in each case comprises a means which ensures pressure equalization between the container for system liquid or the container for liquid waste and the glovebox.

A preferred embodiment of the apparatus, which is equipped with two containers, i.e. a container for system liquid and a container for liquid waste, is shown schematically in FIG. 6.b. In this embodiment, the gas supply (250) is in operative connection via a line (251), a shut-off member (252) and the line (253) with the headspace of the container (254). The line (256) comes to an end in the container, the end of the line coming to an end at a distance of approx. 0.5 to 5 cm above the bottom of the container. In this embodiment, in which the line is immersed in the liquid, the line is a dip tube. The cleaning liquid is drawn from the container by the line immersed therein.

A line (257) is in operative connection with the shut-off members (260) and (259). The other end of the shut-off member (260) is in operative connection with the interior of the glovebox. The line, at the end of which is located the shut-off member (259), serves to discharge inert gas.

Furthermore, a coupling (257) is in each case located in the container feed and discharge lines, by means of which coupling the container may be uncoupled from the glovebox and which also ensures that the glovebox remains sealed despite said uncoupling.

The container for liquid waste is preferably connected up in a similar manner as the container for cleaning liquid. In the container for liquid waste, the dip tube is, however, replaced by an inlet tube. In contrast with the dip tube, the inlet tube extends only 1-5 cm into the upper part of the container.

If overpressure prevails in the glovebox, items (250), (251) and (259) may be omitted. The outflow line (258) is then directly in operative connection via the headspace of the container with the shut-off member (252).

In a further advantageous development, the functions of the shut-off members (260) and (261) may advantageously be integrated into the respective couplings (257). This is achieved by using self-closing quick couplings.

Mode of operation of the preferred embodiment of the apparatus shown in FIG. 6.b. In the base state, the container is uncoupled and the shut-off valve (260) closed.

The container is connected to the glovebox via the couplings (257). Once the waste gas shut-off member (259) and the gas supply shut-off member (252) have been opened, a gas stream is set in motion from the gas supply through the headspace of the container into the exhaust air. The volume of the headspace of the container should be exchanged at least five times, more preferably ten times and still more preferably twenty times. The shut-off members (252) and (259) are then closed. In order to avoid any pressure buildup in the container, the shut-off member (252) is closed first followed by the shut-off member (259) after a time delay. The time delay amounts to at least ten seconds. The shut-off members (260) are then opened.

In the simplified form with self-closing quick couplings, the line (253) with an open shut-off member is first connected. Due to the overpressure in the interior of the glovebox, the inert gas immediately begins to flow through the container. The atmospheric contaminants are sufficiently removed when the volume of the headspace of the container has been exchanged preferably five times, more preferably at least ten times and particularly preferably twenty times by the inert gas.

If, for example, a container has a free headspace volume of three liters, a line leading to this container has an internal diameter of 4 mm and a length of 1 m and air is flowing at 100 normal liters per hour through the line, exchanging the gas ten times will take approx. 2 minutes.

If overpressure prevails in the glovebox, the inert gas for inertizing the containers may also be drawn directly from the glovebox instead of from the external container. To this end, line (251) is connected directly to the glovebox. Outflow from the container then proceeds via line (258). Valve (260) and the associated length of line may then be omitted. In this case, an adjustable throttle device in line (258) is important so that the overpressure acting in the glovebox may be maintained.

### Production of Electrochemical Cells

The invention also relates to a method for producing electrochemical cells using the apparatus according to the invention. The method involves assembling components, introducing electrolyte and sealing the cells. Components E1 to E5 are picked by means of a gripper from depressions of at least one tray and assembled in an assembly chamber. The method is characterized by the steps stated below:
(i) positioning a lower casing element (E1) in the recess of an assembly chamber (4) which is located in a mount on the assembly location;
(ii) positioning and aligning an electrode (E2) on the casing element in the assembly chamber recess;
(iii) dispensing a first part of a selected electrolyte onto the surface of the electrode located in the recess;
(iv) positioning and aligning a separator (E3) on the surface wetted with electrolyte; electrode on the separator wetted with electrolyte;
(v) dispensing a second part of the selected electrolyte onto the surface of the separator located in the recess;
(vi) positioning a counter-electrode (E4) to the electrode arranged in step (ii) on the separator wetted with electrolyte;
(vii) positioning an upper casing element (E5) in the assembly chamber recess; (viii) sealing the stack of cell components with a tool, the individual steps being carried out separately or in combination with one another.

Individual steps may be combined because the individual components may already be firmly connected to other components before the method is carried out. For example, the individual electrodes may be firmly connected to the respective part of the casing which has already been premanufactured.

In a preferred embodiment of the method, the individual components are weighed with the balance before being positioned in the assembly chamber recess.

In this way, the electrodes are matched with regard to ion absorption capacity.

The weighed components preferably comprise at least components E2 and E4 (i.e. the electrodes), these being weighed separately. Weighing the electrodes after conditioning enables a substantial improvement in the quality of the produced cells. On the basis of the weighing data, a matching procedure is carried out which involves combining those counter- electrodes which have a virtually corresponding ion absorption capacity in one cell. The method step of matching the electrodes with regard to ion absorption capacity substantially contributes to producing the cells with particularly high precision and so making it possible to correlate structural and performance characteristics, something which is of major significance when using the apparatus and method according to the invention for research applications.

When matching the electrodes, it is of significance for the ion absorption capacity of anode to be in the range of up to 30% above the value of the ion release capacity of the cathode, preferably the ion absorption capacity of the anode is in the range of up to 20% above the ion release capacity of the cathode, particularly preferably the ion absorption capacity of the anode is in the range of up to 10% above the ion release capacity of the cathode. The ion absorption capacity of the anode should, however, never be smaller than the ion release capacity of the cathode. Ion absorption capacity is preferably calculated by the control system from the weight of the electrode with further constraints being assumed.

As a result of matching the electrodes, those electrodes having a calculated capacity which is not in the preferred range are rejected. In this connection, there is a free depression (or placing depression) in the placing zone (preferably on a tray) which serves to accommodate the electrodes (or other components) which fall outside the narrow tolerance range.

The placing depression is not linked to a specific depression. When a tray with a plurality of depressions is present, the location of the placing depression may be varied. The gripper can resort components which have been placed. The separator elements which are located between the components may also be set down in the placing depressions.

The method may furthermore be carried out in a preferred manner in which the above-stated method steps (i)-(viii) are preceded by the following steps:
(x.1) positioning at least one tray populated with components, preferably a plurality of trays populated with components, in the interior of airlock (23);
(x.2) conditioning the components located on the trays by heating in the temperature range from 20 to 200° C., preferably 100 to 180° C., more preferably 140 to 160° C., for a period in the range from 0.5 to 48 h, preferably in the range from 2 to 36 h, more preferably 4 to 18 h;
(x.3) introducing the at least one tray with the activated components in the placing position or placing positions of the housing, preferably glovebox (8), flooded with protective gas.

When carrying out conditioning according to step (x.2), it is preferred for the components to be exposed to a reduced pressure in the range of <5 mbara, preferably <1 mbara and more preferably <0.1 mbara.

Conditioning of the individual components, in particular of the electrodes and the separators, during the inward transfer process is of central significance for numerous types of electrochemical cells. It must, however, also be borne in mind that the separators have lower thermal stability than the electrode materials.

In a preferred embodiment of the method according to the invention, the separators are conditioned at a temperature of room temperature up to 70° C., preferably of 30 to 60° C., and the electrodes at a temperature in the range from room temperature up to 150° C., preferably of 40 to 120° C. For example, the airlock for inward transfer has two different temperature zones, such that the trays with separators and the trays with electrodes are conditioned simultaneously in the different temperature zones of the airlock. In another embodiment, the separators and the electrodes are conditioned sequentially.

The specific protective gas atmosphere in the glovebox (8) is selected on the basis of the respective types of electrochemical cells which are being manufactured in the glovebox (8).

The atmosphere within the housing is preferably monitored and controlled when carrying out the method according to the invention. If the method relates to the production of Li-ion cells, argon is preferably used as the protective gas, the protective gas, preferably argon, exhibiting an overpressure, the value of which is in the range from 0.1 to 100 mbar, more preferably a value from 1 to 50 mbar, above atmospheric pressure.

It is furthermore preferred in the method for producing Li-ion cells for the content of water vapor in the glovebox (8) to be <100 ppm, more preferably <10 ppm and particularly preferably <1 ppm and/or the oxygen content preferably to be <1000 ppm, more preferably <100 ppm and still more preferably <10 ppm.

A method for producing ion cells according to one of claims 8-12, wherein the method steps are followed by the following step:
(y.1) outward transfer of the trays populated with manufactured cells from the housing through a second airlock (10).

Spatially separating inward transfer of trays with components by means of a first airlock (23) and outward transfer of finished cells by means of a second airlock increases the flexibility of the apparatus. It should also be mentioned in this connection that conditioning of the components and in particular of the electrodes is one of the time-consuming method steps which have an influence on the duration of the entire production process. It is therefore advantageous to have at least one further airlock available. The second airlock (10) may, however, be of a simpler design than the first airlock (23), for example without heating means. The second airlock is therefore preferably used for introducing components which are not subjected to thermal treatment or for outward transfer of the finished cells or of empty vessels.

### Production of Coin Cells (Crimped Cells)

The mode of operation of different developments of the method and apparatus is described in detail below but this description is not intended to limit the invention.

When assembling coin cells, a press is located in the assembly zone.

The press is equipped with a mobile die. In the die, there is a depression. The die may be driven using any drive means known to a person skilled in the art, with electrical linear spindles, linear motors or pneumatic pistons being preferred. In order to simplify accessibility, the die is pushed out beneath the punch and, like a drawer, moved into the gripping zone of the gripper system. In this pushed-out position, it is populated in succession with the cell components. For the purpose of sealing the cell, the mobile die containing the cell is moved under the punch and then the cell is pressed together with the punch.

### Production of Pouch Cells

The station for manufacturing pouch cells comprises a lower body, in which a well for accommodating the foil-like components of the cell is located. At the sides are preferably located hook-like structures (like fine saw blades) or flexible strips which, in the case of easily bent foils, prevent the foils from curling. Located above the well is a laterally displaceable heated means which may be lowered onto the base member for heat-sealing the laterally projecting strips of the foil casing on three sides. A likewise movable heat-sealing device is located in the heat-sealing station for heat-sealing the fourth side. The heat-sealing means are located under a vacuum bell. On the side on which the one-sided sealing bar is located, there is a displaceable tongue. Once the lower casing foil has been laid, this tongue is pushed a few millimeters over lower casing foil, so that a spacing is maintained between the lower and the upper casing foil (in a similar manner to a bookmark located between the pages of a closed book).

The entire station may be tilted by a few degrees via a joint, such that the side where the tongue is located points upward. A channel may preferably be incorporated into the top of the tongue, via which a liquid may be introduced into the interior of the foil pouch. Two or more of the spacing tongues are furthermore preferred.

In a preferred embodiment, there is a scanner, preferably a barcode scanner, more preferably one-dimensional or two-dimensional, located in the gripping zone of the positioning system (3). The individual parts or at least the finished cell receive(s) a barcode, so ensuring better traceability of the manufactured cells. Labeling and recording is of central significance to the field of use of the apparatus in the field of high throughput research, since it is possible to produce a large number of different cells. The manufacturing parameters for the individual cells are acquired by the sequence control system. Subsequent traceability and identification of cells is of great significance in connection with the apparatus according to the invention.

At another location in the gripping zone of the positioning system (3), there is a downwardly directed camera (25) with image evaluation software. This camera is used in order to inspect the surface of the electrodes and to evaluate the electrodes, which point downward with the supporting foil, with regard to optically recognizable defects. Visual inspection of the electrodes also contributes to improving the apparatus according to the invention and the method according to the invention. The influence of the surface structure of the electrodes may also be investigated purposefully.

Using the apparatus according to the invention and the method according to the invention, it is possible to produce more than fifty cells/day, preferably more than one hundred cells/day and more preferably more than two hundred cells per day. A very low production reject rate may simultaneously be achieved, the reject rate amounting to <1%, preferably <0.5% and still more preferably <0.1%. Since a particular characteristic of the apparatus according to the invention is that it is possible to vary the production parameters of the cells in many respects, the output of the apparatus is subject to an upper limit. This is because the apparatus is not an apparatus for production line manufacture of cells of an identical structure. The upper limit for production capacity is in the range from 200 to 800 cells per day, preferably from 200 to 400 cells per day. Particular characteristic features are the low reject rate and the elevated quality of the manufactured cells. The elevated quality of the manufactured cells is associated with the precision of positioning and with the matching of the ion absorption capacity of the electrodes.

It could, however, be conceivable to increase the output of the apparatus according to the invention still further by arranging individual elements in parallel or operating a plurality of apparatuses according to the invention in parallel. Although an upper limit is thus stated with regard to output, it is not completely inconceivable to increase output by modifications.

### Method

In a preferred embodiment of the method, the individual production steps are carried out in a fixedly predetermined sequence.

The method is specified below in an embodiment for producing pouch cells, the method comprising in this embodiment the following steps:

a.1) laying the lower casing foil in the assembly position (2),

a.2) laying and aligning an electrode, cathode or anode,

a.3) distributing a predetermined portion of the electrolyte in the form of a few drops on the surface of the electrode,

a.4) laying and aligning a separator,

a.5) further sprinkling with a predetermined second portion in the form of a few drops of electrolyte,

a.6) inserting one or more spacers (tongues) for subsequent filling with electrolyte,

a.7) laying the electrode of the opposite polarity with respect to the first electrode, anode or cathode,

a.8) sealing the casing foils on three sides,

a.9) tilting the foil stack sealed on three sides such that the spacer points upward,

a.10) filling with the final predetermined portion of electrolyte,

a.11) alternately applying a vacuum and admitting inert gas,

a.12) removing the spacer,

a.13) heat-sealing the side which is still open,

a.14) removing the completely welded foil stack for further use.

In a further preferred embodiment, the apparatus and the method are used for producing coin cells.

B. Production of a coin cell comprises the following steps:

b.1) laying the lower part of the casing in the assembly position (4), wherein the spring and pressure plate for pressing the electrodes have already been inserted in the casing part,

b.2) laying an electrode, cathode or anode,

b.3) wetting the electrode with a predetermined portion of electrolyte,

b.4) laying the separator,

b.5) wetting the separator with a predetermined second portion of electrolyte,

b.6) laying the electrode which is oppositely polarized with respect to the first electrode, anode or cathode,

b.7) laying and gently pressing the upper part of the casing,

b.8) pressing the casing in a hydraulic press,

b.9) removing the cell for further processing.

The temperature-controllable airlock (23) serves for inward transfer of parts (components) and holders into the housing (8), in which the ion cells are assembled by the individual production units working together. In a preferred embodiment, the temperature-controllable airlock (23) is equipped with a vacuum pump, which may reduce pressure to a value of <100 mbara, preferably <10 mbara, more preferably <1 mbara and particularly preferably <0.1 mbara. In a further preferred embodiment, the interior of the temperature-controllable airlock is heated or cooled, wherein a value in the range from 10 to 150° C. and preferably from 20 to 120° C. is selected.

When taking samples, the camera (25) may also be used for inspecting the surface of the electrodes. Algorithms which differ from those used for correcting spatial location are naturally required for image recognition.

The housing (8) and also the airlock (23) may be flooded or flushed with inert gas. Argon is preferably used as the inert gas. In a preferred embodiment of the method according to the invention, the interior of the housing is placed under overpressure, wherein the pressure value ranges from 0.1 to 100 mbar, preferably from 1 to 50 mbar above atmospheric pressure.

The gas atmosphere within the housing may be precisely predetermined and monitored. The water vapor content is preferably <100 ppm, more preferably <10 ppm and particularly preferably <1 ppm. The oxygen content within the housing is preferably <1000 ppm, more preferably <100 ppm and still more preferably <10 ppm.

### Development of Electrochemical Cells

The cells produced by means of the apparatus according to the invention and the method according to the invention are tested with regard to their performance characteristics and the test data are stored in a database. On completion of the development cycle, the performance characteristics are evaluated and analyzed in the light of the respective production parameters.

In a preferred embodiment, the apparatus according to the invention and the method according to the invention are part of a development cycle for developing electrochemical cells which comprises the following steps:

I. software for planning the manufacture of electrochemical cells, and specifically for a plurality of cells with the production parameters being varied from cell to cell

II. controlling the installation for (automated or semi-automated) production (variation of production parameters)

III. testing the different electrochemical cells with a sensor, preferably in parallel

IV. database for acquiring structured results

V. algorithm for optimizing the cycle.

After completion of a first development cycle, the analytical result from characterization of the cells may be used to devise a production plan for a second development cycle. The entire development cycle may be iterated with the process parameters, in particular electrolyte characteristics and cathode characteristics, being varied.

### BRIEF DESCRIPTION OF THE FIGURES

FIG. 1 shows a schematic diagram of the assembly apparatus in the form of a plan view. The apparatus shown is equipped with two airlocks (23, 10). The placing locations (13, 15, 17, 19) are populated in the interior of the glovebox with four trays, a tray with electrolyte vessels (no reference signs) being located above the placing locations.

FIG. 2.a shows a schematic depiction of a component of a cell (102), which component is lying in the indentation (101) of a separator element (103).

FIG. 2.b shows a schematic depiction of a stack-shaped arrangement of five separator elements (103) and five components (102). In the outer zone of the upper side of the individual separator elements are located depressions, into which are fixed the centering lugs of the separator elements located thereabove.

FIG. 2.c shows a side view of a tray (152), in which two populated depressions and a gripper for handling elements may be seen.

FIG. 3 shows a schematic depiction in plan view of a tray which is equipped with four depressions. Three of the depressions are populated with components and separator elements and the fourth depression is left free of components.

FIG. 4.a shows a schematic depiction of the method steps when matching the electrode elements, which are firstly transferred from the stack (200) to the balance (201) and then, as a function of the weighing result, supplied either to the assembly station (202) or to the waste position (203). The elements which are placed in the waste position are not intended for further use and are disposed of.

FIG. 4.b shows a schematic depiction, corresponding to the flow diagram shown in FIG. 4.a, of the method steps when matching the electrode elements. In contrast with the diagram shown in FIG. 4.a, the apparatus is equipped with separate stacks for electrode elements, such that the cathode and the anode are supplied from separate stacks.

FIG. 5.a shows a schematic diagram in plan view of a tray equipped with 6×3 depressions, each side of which tray comprises two coupling elements (220, 222). (Hook-shaped coupling elements in plan view.)

FIG. 5.b shows a side view of two trays which are connected to one another via hook-shaped coupling elements (220).

FIG. 5.c shows a schematic depiction of a tray equipped with 6×3 depressions, which is similar to the tray in FIG. 5.a but comprises other magnetic coupling elements on the side.

FIG. 6.a shows a schematic depiction of a magnetic coupling element. Detail diagram of the coupling element (220) from FIG. 5.c.

FIG. 6.b shows a schematic depiction of an apparatus which is equipped with containers for cleaning liquid or liquid waste.

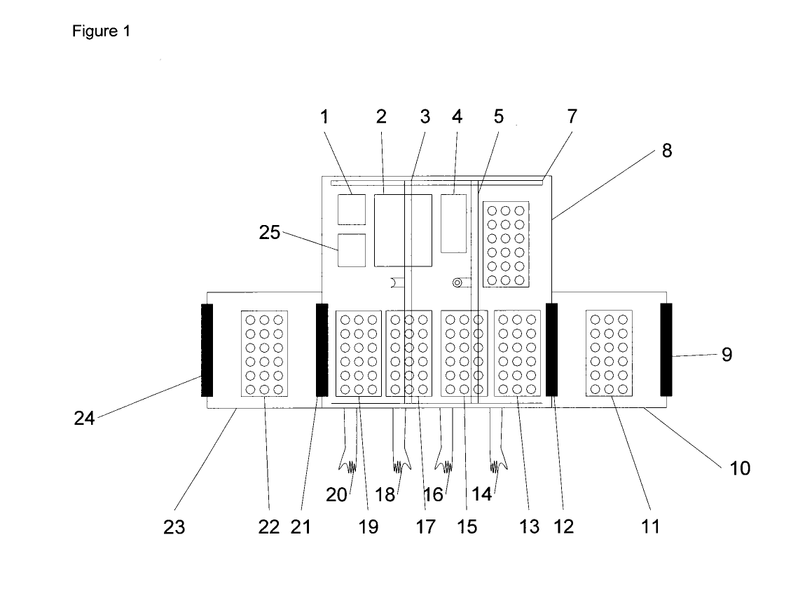

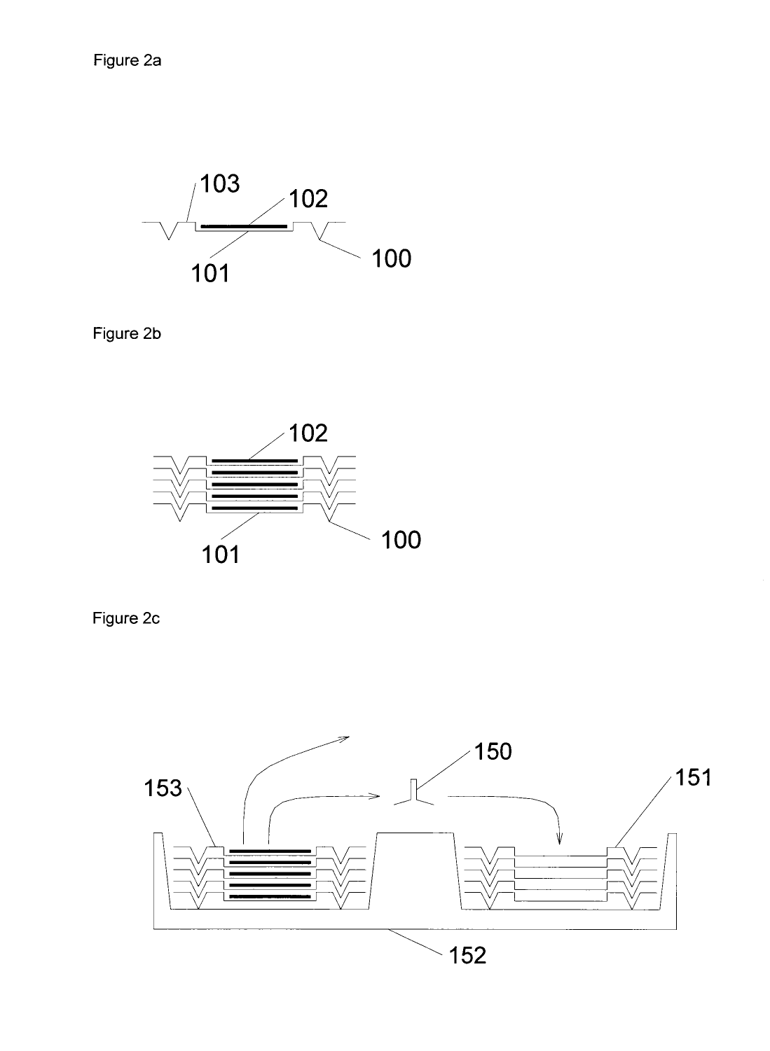

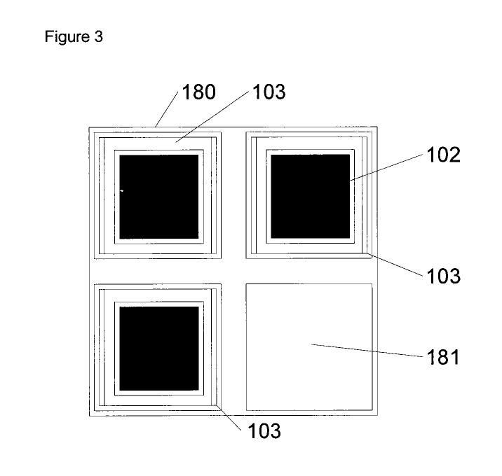

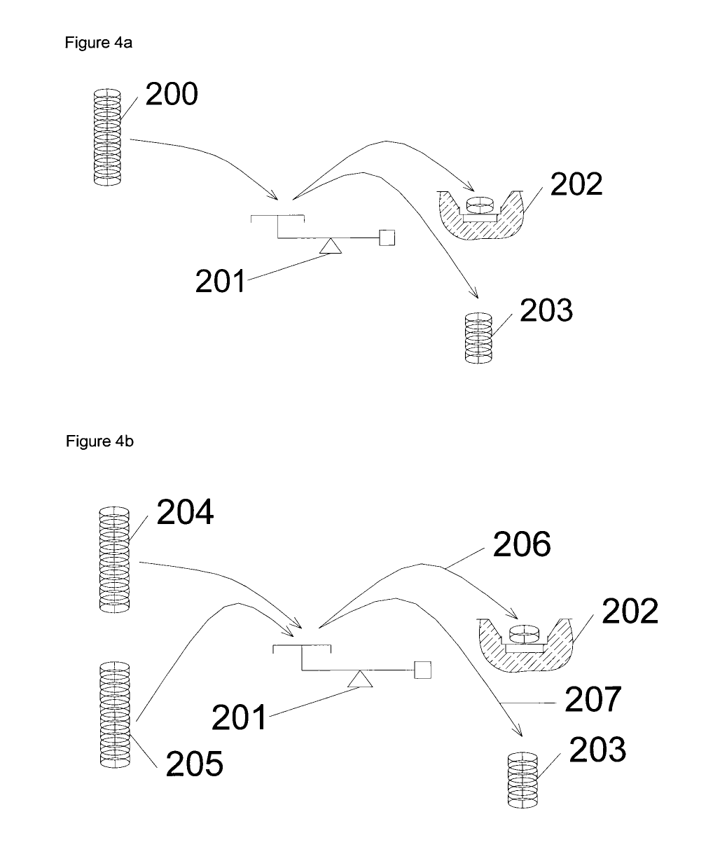

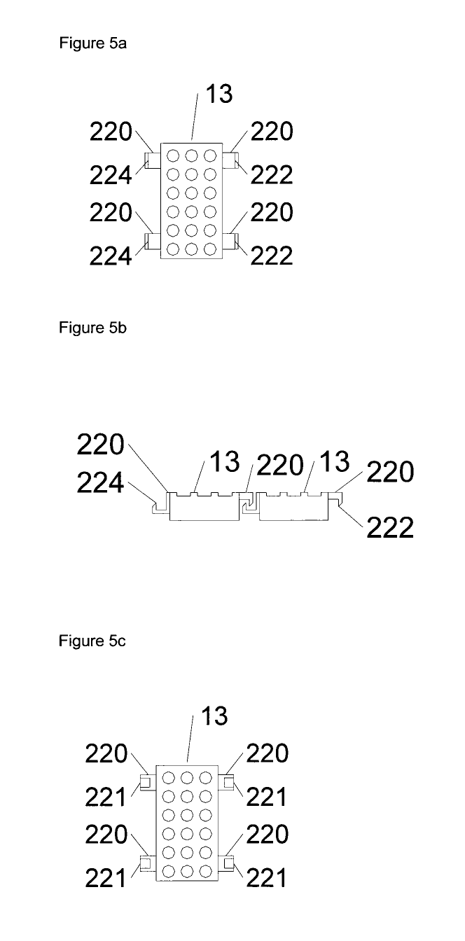

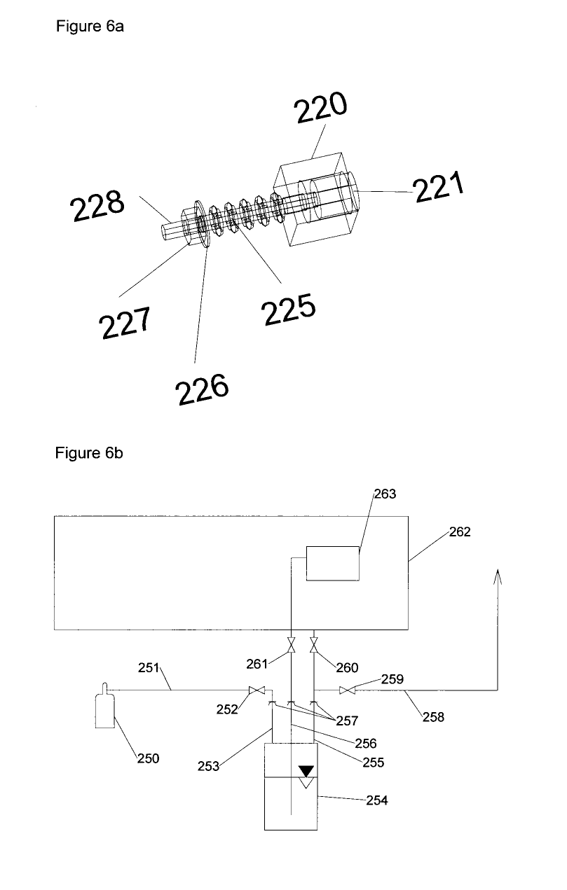

### LIST OF REFERENCE SIGNS

1—Balance

2—Assembly station for pouch cells

3—Handling system for the individual components of the cells, in the present case taking the form of a gantry system

4—Assembly station for coin cells

5—Handling system for liquids, in the present case in the form of a pipetting arm

6—Not present

7—Rail system, handling system, in the present case in the form of a gantry system

8—Glovebox, zone for assembly module

9—Airlock door

10—Airlock without heating, inward or outward transfer of objects not requiring thermal treatment.

11—Placing location for objects not requiring heat treatment, for example vials for liquids

12—Airlock door in the interior for separating assembly zone and airlock zone

—13, 15, 17, 19—Placing locations for trays for the constituents of the cells to be assembled. These are cathodes, anodes, separators and casing parts. The trays are firmly clamped on a retaining system, such that a definite position with regard to the handling system is obtained.

—14, 16, 18, 30—Gloves, providing a hermetic seal from surroundings. They allow handling of the racks.

21—Airlock door between heated airlock and working zone

22—Placing location for objects which are subjected to conditioning steps; for example cathodes and anodes

23—Heated airlock

24—Airlock door to outside

25—Camera for measuring position and recognizing defects

100 —Centering lug in the outer zone of the bottom of the separator elements

101—Indentation for accommodating cell constituents

102—Mechanical components of the cell, namely cathode, anode, separator, casing part(s)

103—Separator element

150—Gripper of the handling system

151—Empty separator element

152—Tray

153—Separator elements populated with components

180—Tray

181—Depression

200—Cathode or anode supply

201—Balance, resolution at least +/−0.5 mg, preferably +/−0.1 mg, more preferably +/−0.05 mg

202—Assembly station

203—Waste position

204—Cathode supply

205—Anode supply

206—Method step in the event that component is within tolerance margin

207—Method step in the event that component is outside tolerance margin

220—Coupling

221—Magnet

222—Hook

224—Hook, complementary to hook (222)

225—Spring

226—Pressure distribution disk

227—Retaining means, for example nut

228—Holding rod

250—Gas supply for inert gas

251—Line for supplying inert gas

252—Shut-off for inert gas

253—Line into container for inert gas

254—Liquid container

255—Outlet line for inert gas

256—Container for cleaning liquid; the variant shown is that with a dip tube for supply, the tube (256) comes to an end a few cm above the bottom of the container; in the variant for discharging liquids, the tube (256) extends only a few cm into the container

257—Couplings for separating the container from the installation

258—Line for discharging inert gas

259—Shut-off for the discharge line

260—Shut-off on installation for feed/discharge line

261—Shut-off on installation for feed/discharge line

262—Glovebox

263—Apparatus in the interior of the glovebox with requirement for liquid

1. An apparatus for producing electrochemical cells with at least one placing location (13, 15, 17, 19), an assembly location (2, 4), a positioning system (3) with gripper (150), an automated pipetting machine (5) with cleaning station, a tool for sealing cells assembled by stacking and at least one tray with depressions for accommodating components, the number of depressions being in total ≧two, preferably ≧four, particularly preferably ≧six.

2. The apparatus for producing electrochemical cells according to claim 1, wherein the apparatus comprises a balance (1) and/or at least one camera (25), the camera (25) being arranged in the region of the base plate of the apparatus.

3. The apparatus for producing electrochemical cells according to claim 1, wherein the apparatus comprises means for moving the tray to the at least one placing location (13, 15, 17, 19) or the trays to the placing locations.

4. The apparatus for producing electrochemical cells according to claim 1, wherein the electrochemical cells are Li-ion cells and the modules of the apparatus are enclosed by a housing (8), preferably a glovebox, and the housing is in operative connection with at least one airlock (23), preferably two airlocks (23, 10). The glovebox (8) contains a means which keeps out unwanted constituents of the normal atmosphere.

5. The apparatus for producing Li-ion cells according to claim 4, wherein the at least one placing location comprises means for recognizing the position of the trays.

6. The apparatus for producing electrochemical cells according to claim 1, wherein at least one of the zones stated below is provided with a guide: placing locations (13, 15, 17, 19), assembly zone (2, 4) and/or airlock zone (23, 10).

7. The apparatus for producing Li-ion cells according to claim 1, wherein at least five of the six depressions of the at least one tray are populated with cell components, only one specific type of component being located in each individual one of the five depressions, the components have a stack-shaped arrangement and separator elements (103) are in each case arranged between the stacked components.

8. A method for producing redox cells by means of an apparatus according to claim 1, in which components E1 to E5 are picked from depressions of at least one tray by a gripper and assembled in an assembly chamber, the method being characterized by the following steps:
(i) positioning a lower casing element (E1) in the recess of an assembly chamber which is located in a mount on the assembly location;
(ii) positioning and aligning an electrode (E2) on the casing element in the assembly chamber recess;
(iii) dispensing a first part of a selected electrolyte onto the surface of the electrode located in the recess;
(iv) positioning and aligning a separator (E3) on the surface wetted with electrolyte;
(v) dispensing a second part of the selected electrolyte onto the surface of the separator located in the recess;
(vi) positioning a counter-electrode (E4) to the electrode arranged in step (ii) on the separator wetted with electrolyte;
(vii) positioning an upper casing element (E5) in the assembly chamber recess;
(viii) sealing the stack of cell components with a tool, the individual steps being carried out separately or in combination with one another.

9. The method for producing electrochemical cells according to claim 8, wherein, prior to positioning in the assembly chamber recess, components are weighed with the balance and the weighed components at least comprise components E2 and E4 (i.e. the electrodes).

10. The method for producing Li-ion cells using an apparatus according to claim 3, wherein the following method steps:
(i) positioning a lower casing element (E1) in the recess of an assembly chamber which is located in a mount on the assembly location;
(ii) positioning and aligning an electrode (E2) on the casing element in the assembly chamber recess;
(iii) dispensing a first part of a selected electrolyte onto the surface of the electrode located in the recess;
(iv) positioning and aligning a separator (E3) on the surface wetted with electrolyte;
(v) dispensing a second part of the selected electrolyte onto the surface of the separator located in the recess;
(vi) positioning a counter-electrode (E4) to the electrode arranged in step (ii) on the separator wetted with electrolyte;
(vii) positioning an upper casing element (E5) in the assembly chamber recess;
(viii) sealing the stack of cell components with a tool, the individual steps being carried out separately or in combination with one another,
are preceded by the following steps:
(x.1) positioning at least one tray populated with components, preferably a plurality of trays populated with components, into the interior of an airlock (23);
(x.2) conditioning the components located on the trays by heating in the temperature range from 20 to 200° C., preferably 100 to 180° C., more preferably 140 to 160° C., for a period in the range from 0.5 to 48 h, preferably in the range from 2 to 36 h, more preferably 4 to 18 h;
(x.3) introducing the at least one tray with the conditioned components in the placing position or placing positions of the housing, preferably glovebox (8), flooded with protective gas.

11. The method for producing Li-ion cells according to claim 10, wherein when carrying out the conditioning of step (x.2) the components are exposed to a reduced pressure in the range from <5 mbara, preferably <1 mbara and more preferably <0.1 mbara.

12. The method for producing Li-ion cells according to claim 10, wherein during production of the cells the housing (8) is placed under a protective gas atmosphere, preferably with argon as the protective gas, and the pressure preferably assumes a value in the range from 0.1 to 100 mbar, more preferably a value from 1 to 50 mbar above atmospheric pressure.

13. The method for producing Li-ion cells according to claim 10, wherein the water vapor content within the housing (1) while the method is being carried out is <100 ppm, more preferably <10 ppm and particularly preferably <1 ppm and/or the oxygen content is preferably <1000 ppm, more preferably <100 ppm and still more preferably <10 ppm.

14. The method for producing ion cells according to claim 8, wherein the method steps are followed by the following step:
(y.1) outward transfer of the trays populated with manufactured cells from the housing through a second airlock (10).
